(19) United States
(12) Patent Application Publication
(10) Pub. No.: US 2009/0322723 A1
(43) Pub. Date: Dec. 31, 2009

(54) Method and apparatus for disabling a display device

(75) Inventor: Jing WU, San Diego, CA (US)

Correspondence Address: CROWELL & MORING LLP;INTELLECTUAL PROPERTY GROUP, P.O. BOX 14300, WASHINGTON, DC, 20044-4300, US

(73) Assignees: SONY CORPORATION, Tokyo (JP); SONY ELECTRONICS INC., Park Ridge, NJ (US)

(21) Appl. No.: 12/163,685

(22) Filed: Jun. 27, 2008

(51) Int. Cl. G09G 5/00

(52) U.S. Cl. 345/211

(57) ABSTRACT

Method and apparatus for disabling use of a display device. In one embodiment, the method may include detecting a blackout timer setting for a display device, the blackout timer setting indicating a blackout period. The method may further include detecting a current time, determining if the current time lies within the blackout period indicated by the blackout timer, and disabling at least one function of the display device in response to the current time being within the blackout period.

### FIELD OF THE INVENTION

The present invention relates in general to display devices and more particularly to a system and method for disabling a display device.

### BACKGROUND

Content provided by broadcasters and media outlets is typically directed to a variety of audiences. As such, broadcasters typically provide many types of programming directed to a variety of target audiences. While many customers enjoy having a variety of programming available, many customers also desire restricting access to specific programs and programming in general. These customers may desire such restrictions to avoid exposure of children to adult programming. Further, some owners of display devices have felt a need for restricting operations of display devices when monitoring of programming is not otherwise possible.

Prior art systems allow for users of display devices to block channels of received media and prevent viewing of content which may not be suitable for particular audiences. This is typically done by a receiver flagging a channel to be blocked at all times. As such, the prior art systems generally block output of a particular channel. With these systems, operation of the display devices is largely unaffected. Further, these prior art systems do not address receiving or restricting media from separate external devices, such as media players, in any way. An additional limitation of the prior art systems is the inability to block unknown media. Further, the prior art systems do not prevent a user from viewing other channels that are not restricted. Accordingly, there is a need for a method and apparatus to restrict use of display devices.

### BRIEF SUMMARY OF THE INVENTION

Disclosed and claimed herein are methods and apparatus for disabling a display device. In one embodiment, a method includes detecting a blackout timer setting for a display device, the blackout timer setting indicating a blackout period. The method may further include detecting a current time, determining if the current time lies within the blackout period indicated by the blackout timer, and disabling at least one function of the display device in response to the current time being within the blackout period.

Other aspects, features, and techniques of the invention will be apparent to one skilled in the relevant art in view of the following detailed description of the invention.

### BRIEF DESCRIPTION OF THE DRAWINGS

FIG. 1 depicts a simplified block diagram of a display device according to one or more embodiments of the invention;

FIG. 2 depicts a simplified system diagram according to one or more embodiments of the invention;

FIG. 3 depicts a process for disabling one or more functions of a display device according to one or more embodiments of the invention;

FIG. 4 depicts a process for setting a blackout timer for a display device according to one or more embodiments of the invention;

FIG. 5 depicts a process for disabling a display device according to one or more embodiments of the invention; and

FIGS. 6A-6B depict graphical representations of display windows according to one or more embodiments of the invention.

### DETAILED DESCRIPTION OF EXEMPLARY EMBODIMENTS

The present disclosure relates generally to display devices. As will be described in more detail below, a blackout timer may be set to disable a display device for a particular period of time. In that fashion, use of the display device may be restricted. In one embodiment, the blackout timer may be a password protected feature of the display device. According to another embodiment, the blackout timer may be executed by a processor of a display device. Similarly, one or more processes may be provided for setting a blackout timer and executing blackout timer functions.

In another embodiment, the display device may be remotely controlled to allow or restrict use. For example, the display device may be configured to interoperate with a data communication network, such that one or more control signals may be received for the device. Additional details and features of the exemplary embodiments are described below.

When implemented in software, the elements of the invention are essentially the code segments to perform the necessary tasks. The program or code segments can be stored in a processor readable medium. The “processor readable medium” may include any medium that can store information. Examples of the processor readable medium include an electronic circuit, a semiconductor memory device, a ROM, a flash memory or other non-volatile memory, a floppy diskette, a CD-ROM, an optical disk, a hard disk, a fiber optic medium, etc. The code segments may be downloaded via computer networks such as the Internet, Intranet, etc.

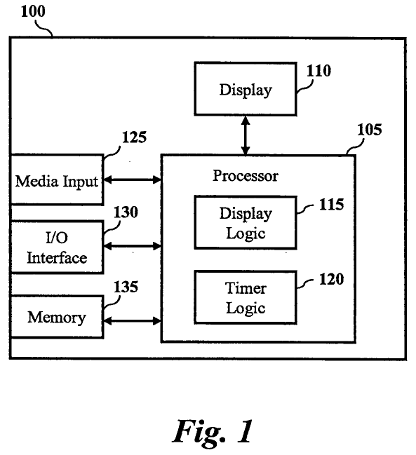

Referring now to the drawings, FIG. 1 is a simplified block diagram of a display device according to one or more embodiments of the invention. As shown in FIG. 1, display device 100 includes processor 105 coupled to display 110, media input 125 and input/output (I/O) interface 130. In one embodiment, I/O interface 130 may comprise one or more terminals to receive commands from a user of the display device 100. Similarly, I/O interface 130 may detect one or more wireless control signals from a transmitting device. In yet another embodiment, I/O interface 130 may comprise an authentication device (not shown) which may employ one of biometric sensor and user authentication functions in general. Display device 100 may relate to one or more of a television, monitor, computer display and display device in general. In one embodiment, display logic 115 of processor 105 may be configured to output one or more signals to display media data received by media input 125 for presentation on display 110. Processor 105 can be any type of processor such as a microprocessor, field programmable gate array (FPGA) and/or application specific integrated circuit (ASIC). It may also be appreciated that processor 105 may be configured to provide a graphical user interface to receive one or more settings by an operator of display device 100.

According to another embodiment, processor 105 may include timer logic 120 to provide a blackout timer for display device 100. In one embodiment, timer logic 120 may include instructions to disable one or more functions of the display device for a period of time, also referred to herein as a blackout period. By way of a non-limiting example, the timing logic 120 may disable components and/or functions of the display device for outputting media. It may be appreciated that the blackout timer may be set for one or more of a particular day and time period.

According to another embodiment, display device 100 may be configured to receive a user request to set, change and/or remove a blackout timer. In one embodiment, one or more terminals of I/O interface 130 may be employed to enter user preferences into display device 100. I/O interface 130 may additionally be employed by a user of display device 100 to issue commands and/or provide a graphical user interface (GUI). Blackout timer settings entered by a user may be stored by memory 135. It may be appreciated that memory 135 may relate to any type of memory, such as ROM or RAM memory. In certain embodiments, timer logic 120 may be configured to set/remove blackout timer based on one or more received settings.

According to another embodiment, display device 100 may include a network interface which may be employed to interoperate with a data communications network. In one embodiment, I/O interface 130 of display device 100 may comprise a network interface connection. However, it may also be appreciated that display device 100 may communicate with a server via I/O interface 130 to request and/or receive blackout timer data. In that fashion one or more functions of the display device 100 may be restricted. By way of example, timing logic 120 may restrict display functions to providing a blackout message during a blackout period. Timing logic 120 may alternatively be configured for one or more of disabling response functions to user commands by the display device 100, disabling output of media by the display device 100, reducing power applied to display device 100 and powering down of display device 100. While timing logic functions and the blackout timer have been described for display device 100, it may be appreciated that an external device coupled to display device 100 may be configured to perform one or more of the above-identified functions.

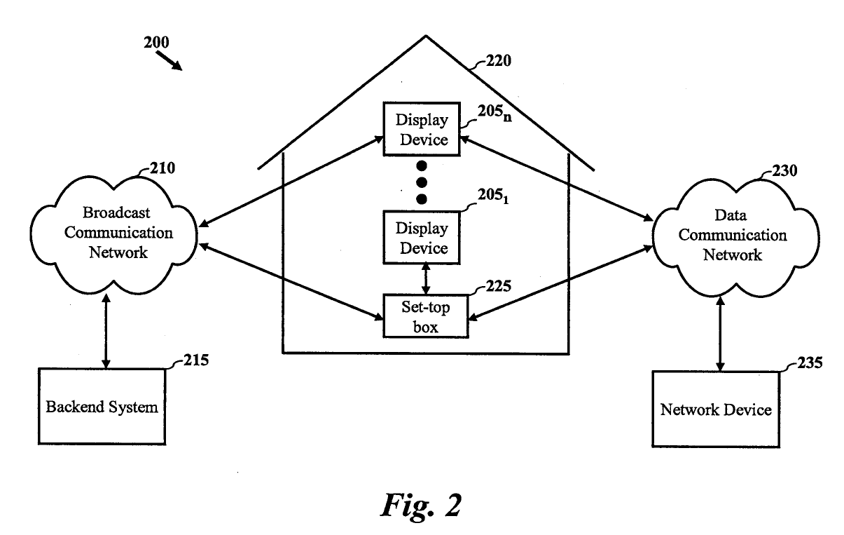

Referring now to FIG. 2, a simplified system diagram is shown of a system according to one or more embodiments of the invention. In one embodiment, a display device (e.g., display device 100) can interoperate with one or more components of system 200. As shown in FIG. 2, system 200 comprises a plurality of display devices 205₁₋ₙ (e.g., display device 100) which can receive one or more broadcast media streams from backend system 215 via broadcast communication network 210. Backend system 215 and broadcast communication network 210 may be used to provide broadcast media corresponding to a multitude of forms (e.g., National Television Standards Committee (NTSC), PAL, Digital Satellite System (DSS), Digital Broadcast system (DBS), Advanced Television Standards Committee (ATSC), Internet Protocol Television (IPTV), etc.). It may also be appreciated that backend system 215 may be configured to transmit live and/or pre-recorded media. Display devices 205₁₋ₙ may be associated with a particular location shown as 220. For example, display devices 205₁₋ₙ may be located in one or more of a residence, commercial location, public area, etc. To that end, display devices 205₁₋ₙ can provide received media to one or more users.

According to another embodiment, broadcast communication network 210 may relate to one of a wired or wireless network. As such, communication links shown in FIG. 2, may correspond to one or more of a telephone line, coaxial line, a fiber optic data line and radio frequency (RF) links. According to another embodiment, broadcast communication network 210 may be configured to transmit additional data in conjunction with, or separately from, media transmitted by broadcast communication network 210.

In certain embodiments, display devices 205₁₋ₙ can interoperate with an optional set-top box 225 to receive media from a broadcast communication network 210. Optional set-top box 225 may be configured to decode received media streams. In one embodiment, optional set-top box 225 may correspond to one of a set top box, television tuner and any television middleware device in general. It may also be appreciated that set-top box 225 may be configured to provide an interface for a data communication network 230. According to another embodiment, display devices 205₁₋ₙ may receive media from media players which may be coupled to an I/O interface (e.g., I/O interface 130) of the display devices.

According to another embodiment, display devices 205₁₋ₙ, can interoperate with a network device 235 via a data communication network 230. In one embodiment, network device 235 may relate to one of a personal computer, mobile device, server and personal computing device in general. Display devices 205₁₋ₙ can provide an internet interface for users. Further, data communication network 230 may be configured to provide network communication capability for display devices 205₁₋ₙ. According to another embodiment, display devices 205₁₋ₙ can interoperate with a network interface (not shown) to receive data.

System 200 may be configured to support network browsing, downloads, and/or streaming of content at display devices 205₁₋ₙ such as music videos, movie trailers, user-generated videos, personalized weather, traffic feeds, map applications, etc. In one embodiment, media may relate to live broadcasts and/or pre-recorded media including location data. In certain embodiments, network interface may be embodied in display devices 205₁₋ₙ for communication over data communication network 230. It may also be appreciated that blackout timer functions of display devices may disable communications of display devices 205₁₋ₙ and network device 235.

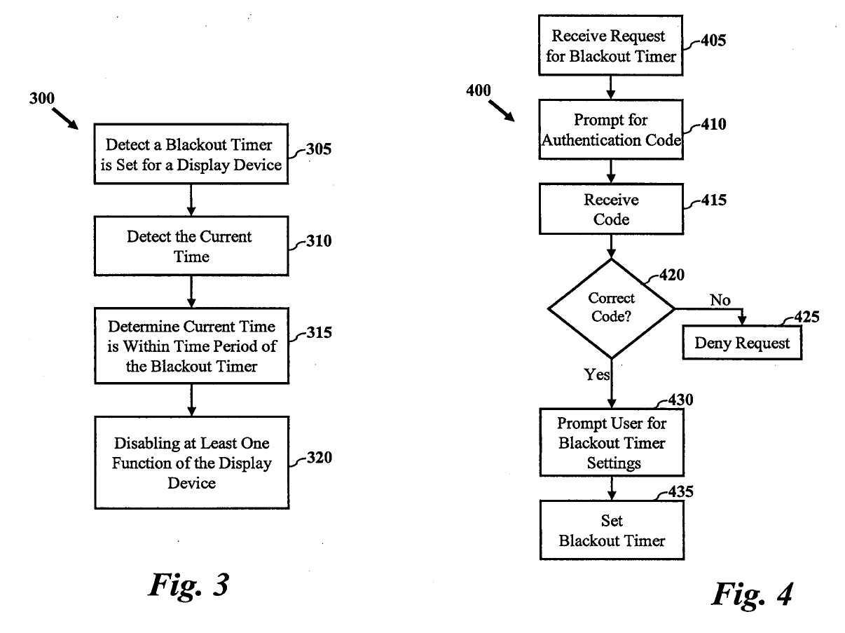

Referring now to FIG. 3, process 300 is shown for disabling a display device (e.g., display devices 100 or 205₁₋ₙ) according to one or more embodiments. In one embodiment, process 300 may be performed by a processor (e.g., processor 105) of the display device. Process 300 may be initiated by detecting that a blackout timer is set for a display device at block 305. In one embodiment, the display device can detect blackout timer settings during startup of the display device. In one embodiment, the processor of the display device can determine if a blackout timer function is set prior to activating a display of the display device. Alternatively, detection of a blackout timer setting may be performed by the display device during operation. It may also be appreciated that the display device can check blackout settings in memory (e.g., memory 135) of the display device. At block 310, the current time may be detected. In certain embodiments, the display device can include an internal timer. Similarly, time may be determined based on a received media and or connection with a data communication network. In certain embodiments, received broadcast data may include information for the current time. At block 315, the processor can determine if the current time period falls within the blackout time period defined by the blackout timer.

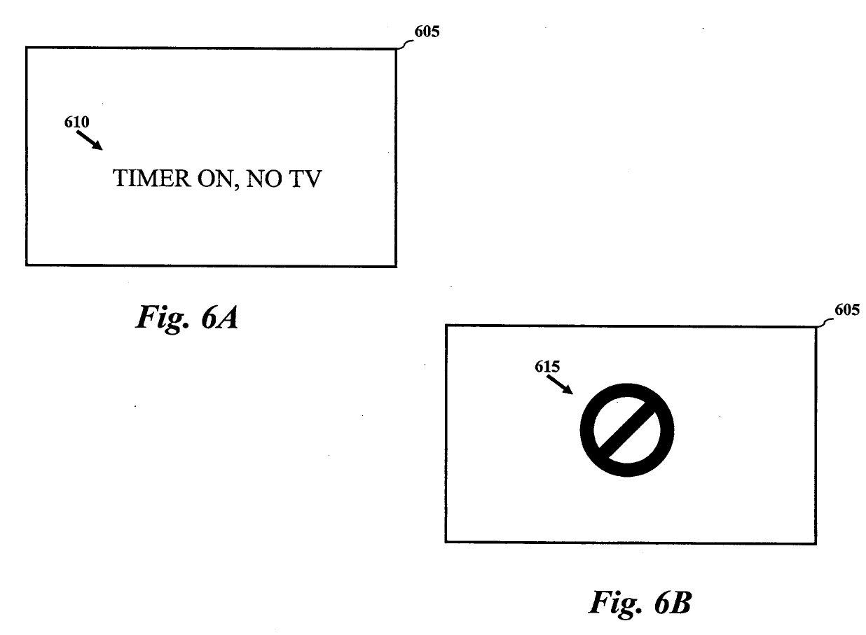

At block 320, the processor can disable one or more functions of the display device. Disabling functions of the display device at block 320 may be based on the current time matching a blackout timer period. In one embodiment, disabling functions of the display device may be performed to restrict use of the display device. According to another embodiment, disabling of the functions at block 320 may include disconnecting power to the display device and remaining in an off position until the blackout timer expires. According to another embodiment, the processor may enter a low power mode such that one or more functions may be provided. For example, the display device can display a user designated message as will be described in more detail below with respect to FIG. 6A-6B. In a further embodiment, the processor can mute all video output, mute all audio output, disable buttons of the display device and/or disable remote control functionality. It may be appreciated that process 300 may be performed by a processor (e.g., processor 105) of the display device during powering on of the display device.

Referring now to FIG. 4, process is shown for setting a blackout timer for a display device (e.g., display devices 100 or 205₁₋ₙ) according to one or more embodiments of the invention. Process 400 may be initiated by receiving a request to set a blackout timer at block 405. In one embodiment, a user can initiate a request to set the blackout timer using one or more of a terminal of the display device and a remote control. In yet another embodiment, the request may be transmitted to the display device over a data communications network by a network device (e.g., network device 235). In certain embodiments, the user can navigate a user interface menu of the display device to set and/or remove a blackout timer for a display device. At block 410, the display device may prompt the user to enter an authentication code. The authentication code may be defined by an authorized user and/or by a manufacturer. According to another embodiment, verification of an authorized user to set the blackout timer may be performed using biometrics, radio frequency identification (RFID) sensor and/or other means of identification. When process 400 relates to remote setting over a data communication network, password entry may be based on a particular device performing the command.

At block 415, the display device can receive an authentication code in response to the prompt of block 410 above. The display device may verify the received authentication code at decision block 420. When the received authentication code is not valid, (“No” path out of decision block 420) the display device can deny request to set, or change, the blackout timer. When the received password is correct (“Yes” path out of decision block 420), the user may be prompted to set and/or update the blackout timer. For example, the authorized user may provide a start time, end time, and/or blackout timer message. In one embodiment, the difference between the start time and end time defines a blackout period. Received settings for the blackout timer at block 430 may be stored by a memory of the display device. The display device can set the blackout timer at block 435. While process 400 has been described for display devices, it should also be appreciated that the process may be similarly performed by other devices including set-top boxes and/or middleware devices in general.

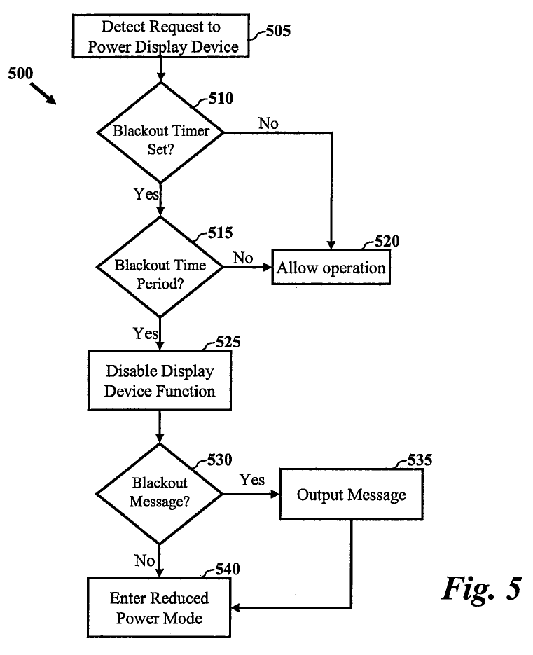

Referring now to FIG. 5, process 500 is shown for disabling a display device according to another embodiment of the process in FIG. 3. As shown in FIG. 5, process 500 may be initiated by receiving a request to power a display device (e.g., display devices 100 or 205₁₋ₙ). In one embodiment, process 500 may be performed by a processor of a display device. Based on a request received at block 505, the display device can determine if a blackout timer is set at decision block 510. When the display device determines a blackout timer has not been set (“No” path out of decision block 510) the processor can allow for operation of the display device at block 520. As such, the display device may function as normal. When the display device determines that a blackout timer is set (“Yes” path out of decision block 510), the display device may check if a blackout timer period is currently in effect at decision block 515. In one embodiment, the display device can check if a blackout period is in effect based on the current time and one or more blackout timer settings. When the display device determines a blackout period is not in effect (“No” path out of decision block 515) the processor can allow for operation of the display device at block 520. When the display device determines that a blackout period is currently in effect (“Yes” path out of decision block 515), a processor of the display device can disable one or more functions of the display device at block 525.

Continuing to refer to FIG. 5, the display device may check for blackout message data at decision block 530. When the display device determines that a blackout message exists (“Yes” path out of decision block 530), the display device may output a message at block 535. It may be appreciated that a message output at block 535 may related to text, video, audio and/or a graphical image. In certain embodiments, the message output at block 535 may relate to personalized instructions for the party restricted to use the display device. For example, parents may create messages to instruct their children for one or more tasks. It may also be appreciated that a plurality of messages may be displayed at different times. Display of a blackout timer message will be described in more detail with respect to FIGS. 6A-6B below. When no blackout message is provided (“No” path out of decision block 530), the device can enter a reduced power mode at block 540. In one embodiment, a reduced power mode may relate to all power being shut off to the display device. According to another embodiment, the display device may enter a limited function mode, during the reduced power mode at block 540, to support minor functions such as displaying blackout timer messages and/or receiving messages from a data communications network.

Referring now to FIGS. 6A-6B, graphical representations are shown of exemplary display windows for the display device of FIG. 1. Referring first to FIG. 6A, display window 605 comprises a text message 610 which may be displayed by a display device (e.g., display devices 100 or 205₁₋ₙ) when a blackout period is in effect. Message 610 may be set by a user which sets the blackout timer. According to another embodiment, message 610 may be a system generated message provided by a memory (e.g., memory 135) of the display device. Message 610 may also be displayed as a scrolling message, flashing message, and/or message for a predetermined period of time. In FIG. 6A, message 610 is shown as text. In certain embodiments, the text of message 610 may relate to a language setting of the display device. It may also be appreciated that message 610 may relate to other languages. According to another embodiment, message 610 may be displayed for the entire blackout period set by the display device and/or the user. Display window 600 may relate to the display window of a television, monitor, computer display and/or display device in general.

Referring now to FIG. 6B, a graphic 615 may be displayed in a display window 605. According to another embodiment of the invention, display window 605 may include presentation graphic 615 that is stationary, moving, intermittent or constantly displayed. Display of graphic 615 may similarly be provided as described above with reference to FIG. 6A. According to another embodiment, graphic 615 may relate to an image or photo loaded by a user at a device port of the display device, such as a media slot, cable connection and/or interface (e.g., I/O interface 130).

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Trademarks and copyrights referred to herein are the property of their respective owners.

What is claimed is:

1. A method for disabling use of a display device, the method comprising the acts of:
detecting a blackout timer setting for a display device, the blackout timer setting indicating a blackout period;
detecting a current time;
determining if the current time lies within the blackout period indicated by the blackout timer; and
disabling at least one function of the display device in response to the current time being within the blackout period.

2. The method of claim 1, wherein the blackout period indicated by the blackout timer setting is based on one or more of a start time, end time and day for the blackout period.

3. The method of claim 1, wherein disabling at least one function of the display device comprises disabling one or more of display functionality, audio output, user input terminal and output functions in general.

4. The method of claim 1, further comprising reducing power consumption of the display device during the blackout period.

5. The method of claim 1, further comprising waiting a predetermined period of time and disconnecting a power source of the display device.

6. The method of claim 1, further comprising displaying a customized message during the blackout period.

7. The method of claim 6, wherein the customized message relates to one or more of an image, audio, movable text and prerecorded message.

8. The method of claim 1, further comprising receiving an authentication code from a user and enabling the at least one function of the display device.

9. The method of claim 8, wherein the authentication code is received over a data communications network.

10. The method of claim 1, further comprising:
receiving a blackout timer setting over a data communications network; and
setting the blackout period based on said blackout timer setting.

11. A display device configured to provide a blackout timer, the display device comprising:
a display; and
a processor coupled to the display, the processor configured to:
detect a blackout timer setting for a display device, the blackout timer setting indicating a blackout period;
detect a current time;
determine if the current time lies within the blackout period indicated by the blackout timer; and
disable at least one function of the display device in response to the current time being within the blackout period.

12. The display device of claim 11, wherein the blackout period indicated by the blackout timer setting indicates one or more of a start time, end time and day for the blackout period.

13. The display device of claim 11, wherein the processor is further configured to disable at least one function of the display device comprises processor executable instructions to disable one or more of display functionality, audio output, user input terminal and output functions in general.

14. The display device of claim 11, wherein the processor is further configured to disable executable instructions to reduce power consumption of the display device during the blackout period.

15. The display device of claim 11, wherein the processor is further configured to wait a predetermined period of time and disconnecting a power source of the display device.

16. The display device of claim 11, wherein the processor is further configured to display a customized message on the display during the blackout period.

17. The display device of claim 16, wherein the customized message relates to one or more of an image, audio, movable text and prerecorded message.

18. The display device of claim 11, wherein the processor is further configured to receive an authentication code from a user and enabling the at least one function of the display device.

19. The display device of claim 18, wherein the processor is further configured to receive the authentication code over a data communications network.

20. The display device of claim 11, wherein the processor is further configured to:
receive a blackout timer setting over a data communications network; and
set the blackout period based on said blackout timer setting.
